(19) United States
(12) Patent Application Publication
(10) Pub. No.: US 2018/0270117 A1
(43) Pub. Date: Sep. 20, 2018

(54) Unified Centralized Network Stack

(71) Applicant: Microchip Technology Incorporated, Chandler, AZ (US)

(72) Inventors: Martin Miller, Karlsruhe (DE); Thorsten Kummermehr, Ubstadt-Weiher (DE)

(73) Assignee: Microchip Technology Incorporated, Chandler, AZ (US)

(21) Appl. No.: 15/916,589

(22) Filed: Mar. 9, 2018

Related U.S. Application Data
(60) Provisional application No. 62/472,643, filed on Mar. 17, 2017.

(51) Int. Cl. H04L 12/24; G06F 9/50

(52) U.S. Cl. CPC H04L 41/0893; G06F 9/5016; H04L 41/12; H04L 41/0803

(57) ABSTRACT

An article of manufacture includes a non-transitory machine-readable medium with instructions that, when loaded and executed on a processor, configure the processor to identify a remote device, configure networking of the remote device, and host a network stack for the remote device. The instructions further configure the processor to identify another remote device, configure networking of the other remote device, host a network stack for the other remote device, and originate read and write requests between the remote devices.

### RELATED APPLICATIONS

This application claims priority to U.S. Provisional Patent Application No. 62/472,643 filed Mar. 17, 2017, the entirety of which is hereby incorporated by reference.

### TECHNICAL FIELD

The present disclosure relates to electronic device networking and, more particularly, to a unified centralized network stack.

### BACKGROUND

Electronic devices may be networked in a variety of topologies using a variety of communication standards or techniques. In a network, the electronic devices must be provisioned with a variety of settings, software, and configurations in order to communicate with other networked electronic devices. Accordingly, each electronic device is dependent upon the settings, software, and configurations of other electronic devices in order to successfully communicate on the network.

Different electronic devices in the network may be provided by different vendors. Moreover, software on such electronic devices in the network may be provided by different vendors. In addition, software on the electronic devices may be different versions or have different settings or other configurations enabled.

A network stack may include software configured to interpret communication protocols. Various software layers may exist within the network stack according to layers defined by the communication protocol. A network stack may typically reside in a given electronic device. A network stack may be loaded, wherein software needed to communicate for a given protocol layer may be loaded into memory for a processor to execute. A network stack may be binded, wherein the software protocols may be set according to an identifier of or hardware of the electronic device, such as a network interface card (NIC).

### BRIEF DESCRIPTION OF THE DRAWINGS

FIG. 1 is an illustration of an example system 100 for centralized network management, according to embodiments of the present disclosure.

FIG. 2 illustrates a more detailed view of system 100 and operation of system 100, according to embodiments of the present disclosure.

### SUMMARY

Embodiments of the present disclosure include an article of manufacture. The article includes a non-transitory machine-readable medium with instructions that, when loaded and executed on a processor, configure the processor to identify a first remote device, configure networking of the first remote device, and host a network stack for the first remote device. In combination with any of the above embodiments, the medium may further include instructions to configure networking of the first remote device based upon a specification and an identifier of the first remote device. In combination with any of the above embodiments, the medium may further include instructions to configure networking of the first remote device based upon a specification and an identifier reported by the first remote device uniquely identifying the first remote device. In combination with any of the above embodiments, the medium may further include instructions to configure networking of the first remote device based upon a specification and an identifier reported by the first remote device identifying a model of the first remote device. In combination with any of the above embodiments, the medium may further include instructions to identify a second remote device, configure networking of the second remote device, host a network stack for the second remote device, and originate read and write requests between the first remote device and the second remote device. In combination with any of the above embodiments, the medium may further include instructions to configure networking of the first remote device by executing a script on a network interface card of the first remote device. In combination with any of the above embodiments, the medium may further include instructions to select a script to execute to configure networking of the first remote device based on a model of the first remote device. In combination with any of the above embodiments, the medium may further include instructions to select a script to execute to configure networking of the first remote device based on whether the first remote device includes a processor. In combination with any of the above embodiments, the first remote device might not include a general-purpose processor. In combination with any of the above embodiments, first remote device might not include a network stack.

Embodiments of the present disclosure may include a processor and an article of manufacture according to any of the above embodiments.

Embodiments of the present disclosure may include a method performed by a processor executing any of the instructions from the above embodiments.

### DETAILED DESCRIPTION

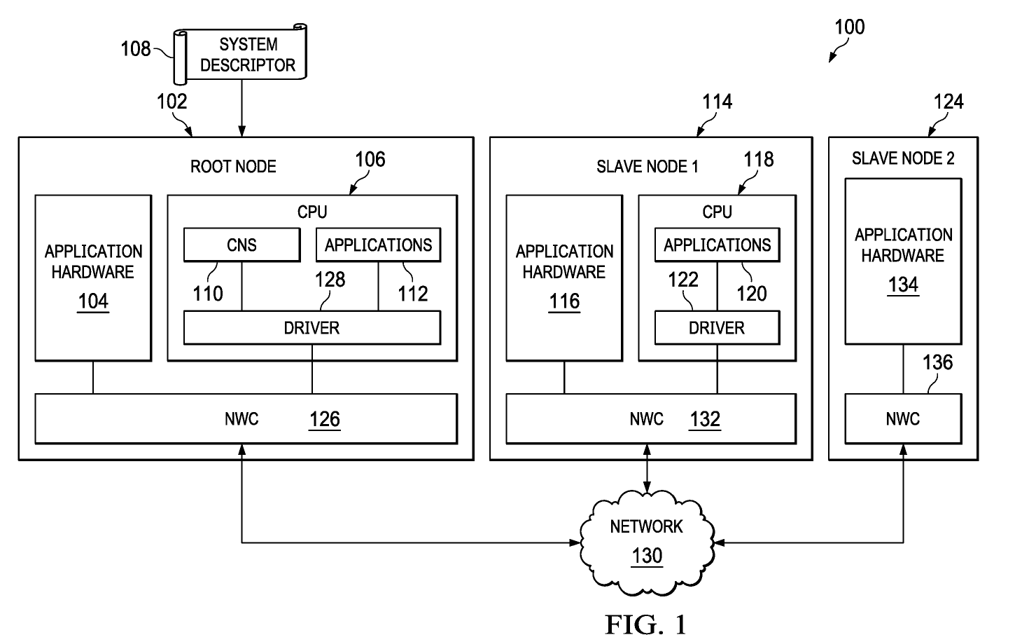

FIG. 1 is an illustration of an example system 100 for centralized network management, according to embodiments of the present disclosure.

Although a particular number of elements are shown in system 100, system 100 may include any suitable number and kind of elements. System 100 may include a root node 102 and one or more slave nodes, such as slave node 114 and slave node 124. Each node 102, 114, 124 may include a suitable configuration of hardware and software. For example, each node 102, 114, 124 may include respective application hardware 104, 116, 134; respective central processing units (CPU) 106, 118; respective driver software 128, 122; respective applications 112, 120; and respective network controllers (NWC) 126, 132, 136. As shown in FIG. 1, slave node 114 and slave node 124 may be implemented in different ways. For example, slave node 124 might not include a CPU and driver, but instead merely include application hardware 134 that communicates with the other nodes. The CPU of each element may be implemented in any suitable way, such as by a processor, microcontroller, core, or other suitable mechanism. Driver software of each element may include a stripped-down network software, as the network stack may be fully or in part offloaded to root node 102. Application hardware 104 may include application-specific processors, application-specific integrated circuits (ASICs), field-programmable gate arrays (FPGAs), integrated circuits, or other mechanisms including circuitry configured to perform specific tasks that might make use of networking. Furthermore, applications 112, 120 may include software executing on the respective CPUs that might make use of networking. Such applications may use further software such as drivers 128, 122 to access respective NWCs. NWCs 126, 132, 136 may be implemented by any suitable combination of circuitry and instructions for execution on a processor, such as a processor within the NWC. NWCs 126, 132, 136 may be configured to connect to the other nodes over a network 130. NWCs 126, 132, 136 may include a network interface card (NIC) or intelligent NIC (INIC). Network 130 may include any suitable network, such as an intranet, the Internet, Ethernet, wireless communication networks, or other network implemented by a suitable protocol and topology. For example, network 130 may allow Ethernet, CAN, TCP/IP, MOST NetServices Function Blocks (FBlocks), or user-specific standards and protocols.

Root node 102 may be configured to perform network management. Network management may be performed at root node 102 by software such as a centralized network stack (CNS) 110. CNS 110 may be implemented by any suitable combination of software, routines, functions, libraries, scripts, applications, or other code for execution by a processor such as CPU 106.

In one embodiment, CNS 110 may be configured to identify network participants in system 100. The network participants may be in the various slave nodes 114, 124. In another embodiment, CNS 110 may be configured to perform address assignment of all network nodes, such as slave nodes 114, 124. In yet another embodiment, CNS 110 may be configured to perform allocation of quality-of-service channels between the elements of the network. In another embodiment, CNS 110 may be configured to assign bandwidth controls between any two points in the network. In yet another embodiment, CNS 110 may be operable to configure the application interfaces of the NWCs 126, 132, 136 of network 130. In another embodiment, CNS 110 may be operable to configure application hardware 104, 116, 134 of nodes of network 130. The configuration of nodes from CNS 110 may be performed through in-band connections or out-of-band connections such as general-purpose input-output (GPIO), I2C, or serial peripheral interface (SPI) busses. In one embodiment, CNS 110 may perform network management for recovery from fail-states. Once provisioned, nodes of network 130 may communicate instead with each other through peer-to-peer networking protocols.

Each slave node 114, 124 may be configured or defined by according to a system descriptor 108. System descriptor 108 may be written or generated and may include coding, such as in extensible markup language (XML), of a target state of each such node. System descriptor 108 may be processed by CNS 110, which may apply settings to slave nodes 114, 124. Settings applied by CNS 110 as described in system descriptor 108 may fully or in part replace network configurations for slave nodes 114, 124. In one embodiment, system descriptor 108 may enable networking of nodes such as slave node 124 that do not include a local multi-purpose microcontroller or local multi-purpose or general-purpose processor. Contents of system descriptor 108 may be implemented by CNS 110 applying settings to slave nodes 114, 124 through their respective NWCs.

In FIG. 1, a single root node 102 is shown. Root node 102 may be implemented in, for example, a server, computer, head unit, or other suitable electronic device. Two slave nodes 114, 124 are shown. Slave node 114 may be implemented in an electronic device that includes a general-purpose or multi-purpose microcontroller or processor. These may include, for example, media players, smart phones, computers, or car head units. Slave node 124 may be implemented in an electronic device that does not include a general-purpose or multi-purpose microcontroller or processor, such as a microphone, head-phone amplifier, power adapter, or a sensor. Various slave nodes may also include screens, touch input, dials, displays, and cameras. CNS 110 operating on root node 102 may be a unified centralized network management stack.

CNS 110 may receive or read system descriptor 108. System descriptor 108 may be stored in memory, entered by a user, or received from another entity and implemented in any suitable data structure, file, or other storage mechanism. System descriptor 108 may describe a list of all supported nodes, a target configuration of each of such nodes, audio-visual connections and settings, a list of communication channels to be established between discovered nodes, and any other suitable information. The channels may be defined as between particular nodes, between slave nodes and the root node, or in general. The channels may be defined according to a communication protocol or medium, such as GPIO, I2C, or SPI.

CNS 110 may be configured to communicate over driver 128 to the NWC 126, 132, 136 of each respective node. The communication using driver 128 may be performed using, for example, USB, I2C, SPI, or MLB. According to system descriptor 108 contents, each local NWC 126, 132, 136 may be set up to include a network interface and an application interface. The application interface may be defined according to a protocol used, such as I2C, USB, MLB, SPI, I2S, GPIO.

When network access is established with given slave nodes such as slave nodes 114, 124, CNS 110 may discover the devices in the network. A stored key, signature, or other identifier in each slave node in the respective NWC may be read and used in communication. The stored identifier may be used to distinguish nodes from each other. The stored identifier may be installed during manufacture of the device or in another suitable configuration process. Subsequently, each node may be assigned a network address by CNS 110. The network interface for each node may be set up by CNS 110. The application interfaces of the respective NWC may be set up. The hardware applications of each node may be connected to the NWC utilizing I2C, GPIO, or SPI. The hardware applications in each node may use these established connections to communicate with each other in various slave nodes 114, 124 and with root node 102. Hardware applications 104, 116, 132 might operate in, for example, plain or bare hardware without a general-purpose processor or microcontroller, such as in the second slave node 124. Respective NWCs 126, 132, 136 may be set up to make sure that streaming data arriving at the NWC is applied to a correct interface with the application hardware or application software 112, 120. During NWC setup, routing, multiplexing, or other connections in network 130 may be made with the corresponding application hardware 104, 116, 134 of the respective device. Furthermore, application software 112, 120 on the respective device may be set up. In some cases, a chip on the respective device may consume the streaming data coming from the NWC. The chip may require booting, initialization, or parameters to set up operation correctly. For example, if an amplifier in application hardware 134 is implemented on slave node 124 without a general-purpose processor or microcontroller, the amplifier might require parameters for selecting mono or stereo mode, setting the volume, or other parameters. The set-up of NWC 136 may be required, but set up of application hardware 134 may be separately defined as required or optional, depending upon the needs of individual applications and devices.

System 100 may operate in contrast to systems wherein devices without a general-purpose processor or microcontroller are connected to other nodes with a host controller, such as USB, I2C, or SPI. The devices are unable to generally network in a peer-to-peer manner with other elements, but instead can only communicate through the host controller to the other devices. Furthermore, system 100 may operate in contrast to most networks that are configured in a decentralized manner. In addition, system 100 may operate in contrast to networks wherein slave nodes require individual software stacks and general-purpose controllers. The result may include a technical improvement over existing networks wherein devices without general-purpose processors are able to communicate with other elements in a peer-to-peer manner, network elements may be centrally configured and thus consistently configured to that communication may occur, and network elements might not require individual software stacks and general-purpose controllers, which may be expensive in terms of processing and storage.

In root node 102, CNS 110 and application software 112 may communicate using driver 128 to NWC 126. Similarly, in slave node 114, application software 120 may communicate using driver 122 to NWC 132. However, as slave node 124 does not include a CPU, functions of application hardware 134 may communicate through NWC 136. In other nodes, application hardware 116 may communicate through NWC 132. Communication between application hardware and an NWC may be made with host controller technology, such as USB, I2C, or SPI. Communication between NWCs 136, 132, 126 may be according to peer-to-peer network protocols and stacks established and controlled by CNS 110.

CNS 110, applications 112, driver software 128, applications 120, and driver software 122 may be implemented by instructions for execution by a processor (such as respective CPUs 106, 118) that, when loaded and executed, configure the processor to perform the functionality of the present disclosure. The instructions may be resident on one or more memories as needed to store or load the instructions for execution. One or more processors or processor cores may execute the instructions. The instructions may be implemented in any suitable script, file, executable, library, application, function, application programming interface, or combination thereof. CNS 110 may be implemented using a state machine monitoring for requests from various slave nodes or input from a user.

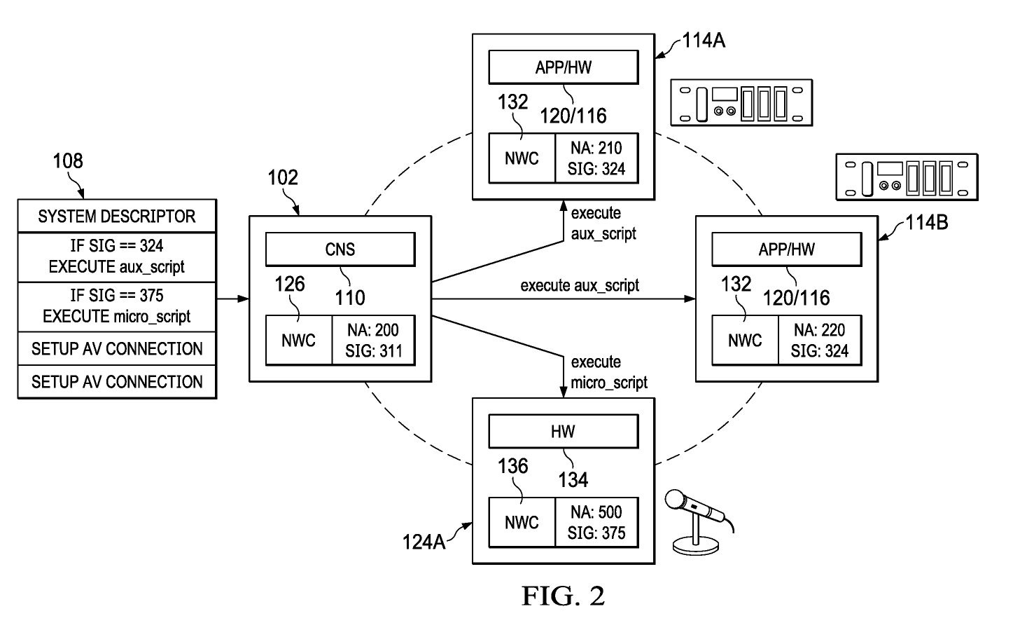

FIG. 2 illustrates a more detailed view of system 100 and operation of system 100, according to embodiments of the present disclosure. In the example of FIG. 2, root node 102 may be managing nodes in an automotive system. The nodes may include two instances of slave node 114, shown as 114A and 114B, and an instance of slave node 124, shown as 124A. Root node 102 may be a head unit for infotainment and vehicle auxiliary system control. Slave node 114A and slave node 114B may include USB hosts, stereo systems, or any other suitable mechanism. Slave node 114A and slave node 114B may include a CPU, while slave node 124A might not include a CPU. Slave node 124A may be, for example, a microphone that might be usable with the other components of system 100.

CNS 110 may configure its own NWC 126 of root node 102. For example, root node 102 may have an INIC in its NWC 126 with a signature of 311. CNS 110 may assign a network address of 200 to root node 102.

CNS 110 may assign network addresses to other nodes. CNS 110 may assign a network address of 210 to slave node 114A, an address of 220 to slave node 114B, and an address of 500 to slave node 124A. Slave node 114A may have a signature from an INIC in its NWC 132 of 324. If slave node 114B is the same make and model of device, slave node 114B may have same signature of 324. In some embodiments, the signature of each slave node may be different, even if two such slave nodes are of the same make and model of device.

CNS 110 may configure slave nodes 114A, 114B, 124A according to identifiers within the slave nodes. For example, CNS 110 may access slave node 114A with an identifier of 324. Based upon the identifier 324, CNS 110 may access system descriptor 108, wherein it is specified that such a device is to be configured with a particular configuration routine. This may be denoted as “execute_aux_script” and may be specific to the type of device implemented by slave node 114A. Moreover, such a script may be for application software, driver software, or other elements that can run on a CPU. The “aux_script” might be for configuring nodes that include MCUs. CNS 110 may execute “aux_script” to configure slave node 114A and assign a network address. Similarly, CNS 110 may execute “aux_script” to configure the applications and NWC of slave node 114B. The two remote nodes might be automobile audio-visual devices of a same or similar type.

CNS 110 may access slave node 124A and determine that slave node 124A has an identifier of 375. As discussed above, slave node 124A may include an electronic device without a microcontroller, such as a microphone (just as an example). Based upon the remote node identification as 375, system descriptor 108 may specify that the remote node is to be configured using a particular script, designated in the example as “micro_script”. While “aux_script” was used to configure remote nodes that include a microcontroller or processor, “micro_script” may be used to configure remote nodes that do not include a microcontroller or processor. CNS 110 may execute “micro_script” to configure NWC 136 of slave node 124A. During setup, CNS 110 may assign slave node 124A the network address of 500. Audio/visual (AV) connections may be established for the nodes.

In one embodiment, CNS 110 may be configured to perform network configuration of slave nodes 114, 124 regardless of whether the slave node includes a processor. Thus, CNS 110 may be configured to execute a script such as “aux_script” or “micro_script” on behalf of the respective slave node. CNS 110 may use the operations of the executed script to remotely control the respective slave node. CNS 110 may apply the operations of the executed script to the addressed destination, whether local or remote. CNS 110 may be connected to slave nodes 114, 124 through an inter-chip communication channel or control channel. Such a channel may be an out-of-band channel.

At each remote node, commands resulting from the script may be received by the respective NWC. The respective NWC may configure itself according to the received script. The NWC may pass I2C and GPIO messages to its local hardware if there is no microcontroller or processor.

Furthermore, CNS 110 may issue bandwidth allocations or quality-of-service criteria to each node. Data connections, bandwidth allocations, audio-video connections, or other parameters may be dynamically changed by reissuance of commands to the nodes. Reconfigurations of remote nodes may be performed, for example, when new devices attach or when devices un-attach from network 130.

After configuration over a control channel, subsequent communication may be performed by sending messages over the network. For example, adjusting volume of an amplifier or selecting a media track may involve such subsequent messages. These messages may be sent over the control channel, upon other channels such as I2C, or upon an Ethernet channel that was established during configuration. The decision of which channel to send the messages may depend upon bandwidth requirements of the messages, as different channels have different bandwidth capacity. CNS 110 may establish what channels are to be used for different kinds of traffic, and may enforce bandwidth limitations according to quality-of-service (QOS) requirements. In case a channel, such as Ethernet, fails, other channels such as the control channel may be used to identify such errors. The failure may be diagnosed with such other channels serving as a back-up channel.

A network stack hosted by CNS 110 may be configured to locally or remotely trigger messages to elements of root 102 and slave nodes 114, 124. The states of port pins of NWCs 126, 132, 136 may be obtained or set as appropriate by CNS 110. Local to slave nodes 114, 124, the states of such port pins may have been set by circuitry, buttons, or other human-machine interfaces at the slave node 114, 124. Thus, a request for information elsewhere in the system may be generated by slave node 124 without a general-purpose processor. The request may be obtained by CNS 110 at a port of NWC 136 and subsequently handled. The request may be, for example, a request to send or receive data, establish a connection with another element, or any other suitable task.

CNS 110 may be configured to generate and control all connections in network 130. CNS 110 may act as a remote control for slave units 114A, 114B, 124A. For example, CNS 110 may establish a connection between a head unit implemented by slave unit 114A and a microphone implemented by slave unit 124A. The microphone of slave unit 124A might not include a multimedia card interface. The communication may be established by CNS 110 provisioning NWC 136. In such an example, an I2C bus master of CNS 110 may manage reads and writes to the microphone. Data and commands to be transferred to and from slave unit 124A may be offloaded to CNS 110. Thus, the existing processing power in root node 102 may be used to run controlling software for remote-controlled nodes. Centralizing control of software in root node 102 may simplify development processes, as only one software instance needs to be developed and deployed. Therefore, only the CNS 110 software stack in root node 102 requires networking knowledge. Developers of software for system 100 might not be required to program as many requirements in the nodes. Instead, developers might only need to configure system descriptor 108. The architecture and topology of system 100 may facilitate system partitioning, board space, and power dissipation for remote devices. Nodes may be developed without additional memory and processing power on remote nodes.

Although example embodiments have been described above, other variations and embodiments may be made from this disclosure without departing from the spirit and scope of these embodiments.

1. An apparatus, comprising:
a processor; and
a non-transitory machine-readable medium;
wherein the medium includes instructions, the instructions, when loaded and executed on the processor, configured to cause the processor to:
identify a first remote device;
configure networking of the first remote device; and
host a network stack for the first remote device.

2. The apparatus of claim 1, wherein the medium further includes instructions for configuring networking of the first remote device based upon a specification and an identifier of the first remote device.

3. The apparatus of claim 1, wherein the medium further includes instructions for configuring networking of the first remote device based upon a specification and an identifier reported by the first remote device uniquely identifying the first remote device.

4. The apparatus of claim 1, wherein the medium further includes instructions for configuring networking of the first remote device based upon a specification and an identifier reported by the first remote device identifying a model of the first remote device.

5. The apparatus of claim 1, wherein the medium further includes instructions for configuring the processor to:
identify a second remote device;
configure networking of the second remote device;
host a network stack for the second remote device; and
originate read and write requests between the first remote device and the second remote device.

6. The apparatus of claim 1, wherein the medium further includes instructions for configuring the processor to:
configure networking of the first remote device by executing a script on a network interface card of the first remote device.

7. The apparatus of claim 1, wherein the medium further includes instructions for configuring the processor to:
select a script to execute to configure networking of the first remote device based on a model of the first remote device.

8. The apparatus of claim 1, wherein the medium further includes instructions for configuring the processor to select a script to execute to configure networking of the first remote device based on whether the first remote device includes a processor.

9. The apparatus of claim 1, wherein the first remote device does not include a general-purpose processor.

10. The apparatus of claim 1, wherein the first remote device does not include a network stack.

11. An article of manufacture, comprising a non-transitory machine-readable medium, the medium including instructions, the instructions, when loaded and executed on a processor, configure the processor to:
identify a first remote device;
configure networking of the first remote device; and
host a network stack for the first remote device.

12. The article of claim 11, further comprising instructions to configure networking of the first remote device based upon a specification and an identifier of the first remote device.

13. The article of claim 11, further comprising instructions to configure networking of the first remote device based upon a specification and an identifier reported by the first remote device uniquely identifying the first remote device.

14. The article of claim 11, further comprising instructions to configure networking of the first remote device based upon a specification and an identifier reported by the first remote device identifying a model of the first remote device.

15. The article of claim 11, further comprising instructions to:
identify a second remote device;
configure networking of the second remote device;
host a network stack for the second remote device; and
originate read and write requests between the first remote device and the second remote device.

16. The article of claim 11, further comprising instructions to:
configure networking of the first remote device by executing a script on a network interface card of the first remote device.

17. The article of claim 11, further comprising instructions to:
select a script to execute to configure networking of the first remote device based on a model of the first remote device.

18. The article of claim 12, further comprising instructions to select a script to execute to configure networking of the first remote device based on whether the first remote device includes a processor.

19. The article of claim 12, wherein the first remote device does not include a general-purpose processor.

20. A method, comprising:
identifying a first remote device, the first remote device remote from a root node;
configuring networking of the first remote device from the root node; and
hosting a network stack for the first remote device at the root node.
